(19) United States
(12) Patent Application Publication
(10) Pub. No.: US 2024/0377286 A1
(43) Pub. Date: Nov. 14, 2024

(54) LONG-DISTANCE SAMPLING DEVICE FOR FECES IN A POULTRY HOUSE

(71) Applicant: ANHUI AGRICULTURAL UNIVERSITY, Hefei City (CN)

(72) Inventors: Liangfei FANG, Hefei City (CN); Wenzhao MA, Hefei City (CN); Jun GUO, Hefei City (CN); Haijun BI, Hefei City (CN); Qing LI, Hefei City (CN); Xingdong SUN, Hefei City (CN); Xiaoshuang ZHANG, Hefei City (CN)

(73) Assignee: ANHUI AGRICULTURAL UNIVERSITY, Hefei City (CN)

(21) Appl. No.: 18/433,279

(22) Filed: Feb. 5, 2024

(30) Foreign Application Priority Data
May 9, 2023 (CN) 202310516391.1

(51) Int. Cl. G01N 1/08; A01K 31/04; B64U 30/299; B64U 101/00; B64U 101/70

(52) U.S. Cl. CPC G01N 1/08; A01K 31/04; B64U 30/299; B64U 2101/00; B64U 2101/70

(57) ABSTRACT

A long-distance sampling device for feces in a poultry house is provided. The device includes an unmanned aerial vehicle body including a wireless controller, supporting feet arranged on the unmanned aerial vehicle body, and a sampling unit arranged on the unmanned aerial vehicle body for collecting fecal samples. The sampling unit further includes a sampling power portion arranged in the unmanned aerial vehicle body and a sampling portion arranged on the unmanned aerial vehicle body. The sampling portion further includes a cylindrical sampling tube and a sampling shaft rotatably connected to the sampling tube, spiral blades are fixedly connected to the sampling shaft, and the sampling power portion drives the sampling shaft to rotate. According to the device, it is convenient for workers to take samples in the poultry house, thereby the convenience of sampling is improved, and the workers do not need to get into the breeding areas.

### CROSS-REFERENCE TO RELATED APPLICATION

This patent application claims the benefit and priority of Chinese Patent Application No. 202310516391.1 filed with the China National Intellectual Property Administration on May 9, 2023, the disclosure of which is incorporated by reference herein in its entirety as part of the present application.

### TECHNICAL FIELD

The present disclosure relates to the technical field of poultry breeding and sampling, in particular to a long-distance sampling device for feces in a poultry house.

### BACKGROUND

Poultry house is a kind of building for breeding poultry animals. The poultry house structurally looks like a factory building, which is a house structure with a large space.

During the process of poultry breeding, in order to know the health status of animals, it is required to sample feces of animals. In the current poultry breeding, breeding areas are usually arranged in the poultry house, the animals are bred in a scattered manner in the breeding areas, and the animals are fed by automatic feeding equipment. Only part of passages are arranged in the poultry house. For short-distance sampling, feces are sampled by workers at the side of the passages. However, for sampling feces within the breeding areas, the workers need to get into the breeding areas. Due to the high density of breeding in the breeding areas, the bred animals will obstruct the forward movement of sampling personnel, and the sampling personnel need to drive away the animals when the sampling personnel go forward, which causes inconvenience to the sampling personnel. Therefore, a long-distance sampling device for feces in the poultry house is required, so that workers can conduct a long-distance sampling at the side of the passages to collect fecal samples from within the breeding areas.

### SUMMARY

A purpose of the present disclosure is to provide a long-distance sampling device for feces in a poultry house so as to solve the problem that it is inconvenient to sample feces in the current poultry house.

In order to achieve the above purpose, the following technical solution is provided in the present disclosure:

A long-distance sampling device for feces in a poultry house, the device includes:
an unmanned aerial vehicle body including a wireless controller for controlling flight of the unmanned aerial vehicle body;
supporting feet arranged on the unmanned aerial vehicle body;
a sampling unit arranged on the unmanned aerial vehicle body for collecting fecal samples, wherein the sampling unit includes:
a sampling power portion arranged in the unmanned aerial vehicle body;
a sampling portion arranged on the unmanned aerial vehicle body; the sampling portion includes a cylindrical sampling tube and a sampling shaft rotatably connected to the sampling tube; spiral blades are fixedly connected to the sampling shaft; and the sampling power portion drives the sampling shaft to rotate.

Furthermore, blade protection covers are arranged on the blades of the unmanned aerial vehicle body.

Furthermore, automatic telescopic supporting feet are provided as the supporting feet.

Furthermore, the sampling tube is of a cylindrical structure with an opening at one end, and the opening of the sampling tube is formed in one end, away from the unmanned aerial vehicle body, of the sampling tube.

A preset space is formed between ends, away from the opening of the sampling tube, of the spiral blades and a bottom of the sampling tube for storing the samples.

Furthermore, the sampling portion is detachably connected with the unmanned aerial vehicle body. The sampling device further includes:
a clamping unit fixedly connected to the unmanned aerial vehicle body for clamping the sampling portion.

Furthermore, the clamping unit includes:
two clamping arms arranged on both sides of the sampling portion; the clamping arms are hinged to the unmanned aerial vehicle body;
clamping plates, arranged on the clamping arms; surfaces, close to the sampling portion, of the clamping plates are in an arc shape to fit the sampling portion; and
clamping power portions fixedly connected to the unmanned aerial vehicle body for driving the clamping arms to rotate and clamp the sampling portion.

Furthermore, the clamping arms are hinged to the unmanned aerial vehicle body through clamping shafts, and the clamping power portions each include:
a worm gear arranged at an end of a corresponding one of the clamping shafts;
a clamping power shaft rotatably connected to the unmanned aerial vehicle body; worms rotating in opposite directions are arranged at both ends of the clamping power shaft; the worms are meshed with the worm gears; and
a clamping motor fixedly connected to the unmanned aerial vehicle body for driving the clamping power shaft to rotate.

Furthermore, the device further includes:
a hangar, a centering component is arranged on the hanger to adjust position of the unmanned aerial vehicle body on the hanger;
a sample bank arranged in the hangar; an annular groove is provided as the sample bank; several sampling bases are arranged in the sample bank; the sampling bases are each in a cylindrical shape with an opening at one end; and the sampling portion can be inserted into one of the sampling bases through the clamping unit;
base moving wheels arranged in the hangar for controlling the sampling bases to move in the sample bank; and the base moving wheels are connected with a moving motor.

Furthermore, the base moving wheels are each of a disc-shaped structure with several arc notches at an edge, and the arc notches in the base moving wheels fit the sampling bases.

Furthermore, the clamping arms each include:
a telescopic arm;
a fixed arm, an end of the telescopic arm is slidably connected to the fixed arm; and
a spring; the spring is arranged in the fixed arm, and both ends of the spring respectively abut against the telescopic arm and the fixed arm; and the fixed arm is in a cylindrical shape with an opening at one end.

In conclusion, compared with the prior art, the present disclosure has the following beneficial effects.

The long-distance sampling device for feces in a poultry house according to the embodiment of the present disclosure carries the sampling unit for sampling through the unmanned aerial vehicle. The unmanned aerial vehicle can drive away the animals when landing. Meanwhile, after the unmanned aerial vehicle lands, the sampling unit scrapes the samples. Since the spiral blades are arranged on the sampling shaft, the sampling unit can not only sample, but also temporarily store the samples. After sampling, the unmanned aerial vehicle body flies back to the starting point, so that it is convenient for the workers to take samples in the poultry house, thereby the convenience of sampling is improved, and the workers do not need to get into the breeding areas.

### BRIEF DESCRIPTION OF THE DRAWINGS

FIG. 1 is a schematic diagram of a structure of a long-distance sampling device for feces in a poultry house according to an embodiment of the present disclosure.

FIG. 2 is a front view of a long-distance sampling device for feces in a poultry house according to an embodiment of the present disclosure.

FIG. 3 is a sectional view taken along a line A-A in FIG. 2.

FIG. 4 is a partially enlarged drawing of part I in FIG. 3.

FIG. 5 is a schematic diagram of a structure of a clamping unit in a long-distance sampling device for feces in a poultry house according to an embodiment of the present disclosure.

FIG. 6 is a schematic diagram of a structure of a hanger in a long-distance sampling device for feces in a poultry house according to an embodiment of the present disclosure.

FIG. 7 is a schematic diagram of a structure of a sample bank in a long-distance sampling device for feces in a poultry house according to an embodiment of the present disclosure.

Reference signs in the attached figures:
100, unmanned aerial vehicle body; 110, blade protection cover; 120, guide sleeve;
200, supporting foot; 210, foot pad;
300, sampling unit; 310, sampling portion; 311, sampling tube; 312, sampling shaft; 313, connector; 320, sampling power portion; 321, connecting sleeve; 330, sampling base;
400, clamping unit; 410, clamping arm; 411, telescopic arm; 412, fixed arm; 413, spring; 420, clamping plate; 430, clamping shaft; 440, clamping power portion; 441, worm gear; 442, clamping power shaft; 443, worm; 444, clamping motor;
500, hangar; 510, centering component; 520, hanger upper cover plate;
600, sample bank; and
700, base moving wheel.

### DETAILED DESCRIPTION OF THE EMBODIMENTS

The following clearly and completely describes the technical solutions in the embodiments of the present disclosure with reference to the attached figures in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

### Embodiment I

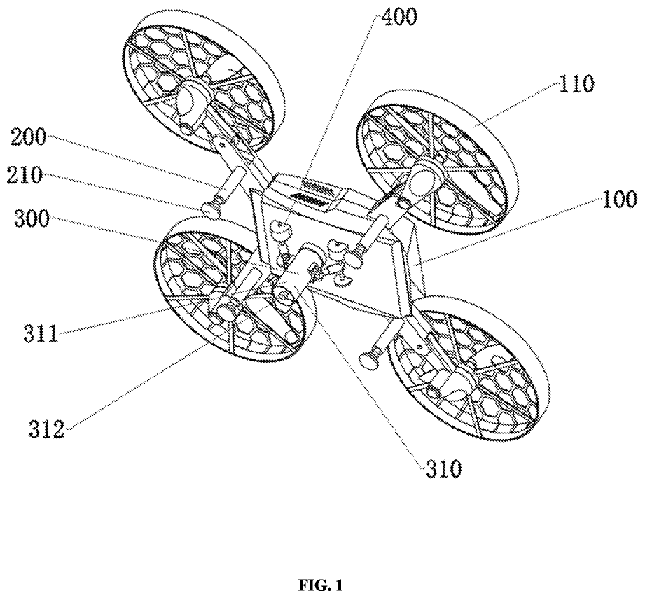

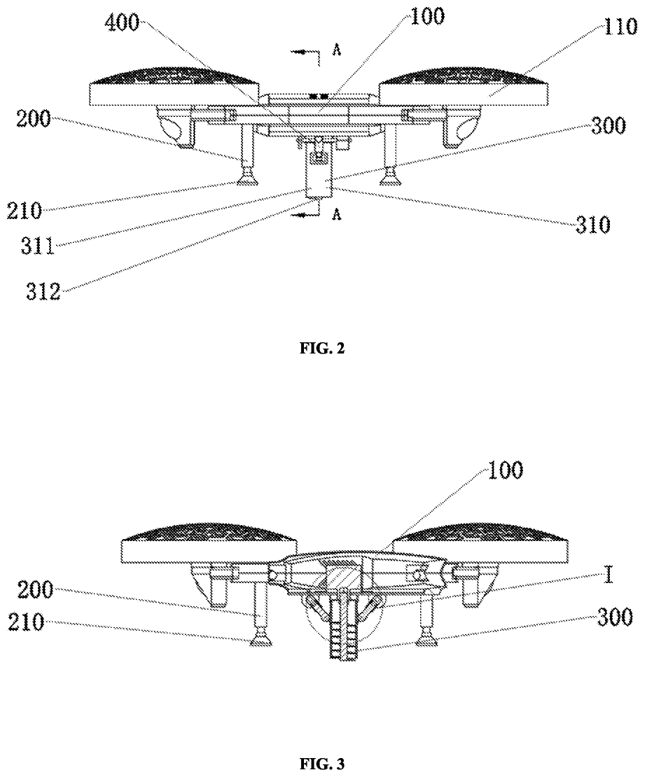

As shown in FIG. 1 to FIG. 3, a long-distance sampling device for feces in a poultry house according to an embodiment of the present disclosure is provided. The device includes:
an unmanned aerial vehicle body 100, the unmanned aerial vehicle body 100 including a wireless controller for controlling flight of the unmanned aerial vehicle body;
supporting feet 200 arranged on the unmanned aerial vehicle body 100;
a sampling unit 300 arranged on the unmanned aerial vehicle body 100 for collecting fecal samples, wherein the sampling unit 300 includes:
a sampling power portion 320 arranged in the unmanned aerial vehicle body 100;
a sampling portion 310 arranged on the unmanned aerial vehicle body 100; the sampling portion 310 includes a cylindrical sampling tube 311 and a sampling shaft 312 rotatably connected to the sampling tube 311; spiral blades are fixedly connected to the sampling shaft 312; and the sampling power portion 320 drives the sampling shaft 312 to rotate.

Specifically, in this embodiment, when feces in a poultry house is collected, the unmanned aerial vehicle body 100 is controlled to fly in the poultry house through the wireless controller, so that the unmanned aerial vehicle body 100 flies directly above a collection site. The unmanned aerial vehicle body 100 is controlled to descend through the wireless controller. When the unmanned aerial vehicle body 100 descends, the sound produced by the rotation of the rotors of the unmanned aerial vehicle body 100 and the airflow produced during the rotation of the rotors can be used to drive away the animals, so that the animals bred in the poultry house are scattered. The unmanned aerial vehicle body 100 falls to the collection site, meanwhile the supporting feet 200 are used to support the unmanned aerial vehicle body 100, and the sampling unit 300 is started through the wireless controller to collect fecal samples. The sampling power portion 320 is powered on to rotate, and the sampling power portion 320 drives the sampling shaft 312 to rotate. The sampling shaft 312 scoops up feces through the spiral blades, and feces are conveyed to an upper end of an interior of the sampling tube 311. After sampling, the unmanned aerial vehicle body 100 takes off and flies back to a starting point.

The long-distance sampling device for feces in a poultry house according to an embodiment of the present disclosure carries the sampling unit 300 for sampling through the unmanned aerial vehicle. The unmanned aerial vehicle can drive away the animals when landing. Meanwhile, after the unmanned aerial vehicle lands, the sampling unit 300 scrapes the samples. Since the spiral blades are arranged on the sampling shaft 312, the sampling unit 300 can not only take samples, but also temporarily store the samples. After sampling, the unmanned aerial vehicle body 100 flies back to the starting point, so that it is convenient for the workers to take samples in the poultry house, thereby the convenience of sampling is improve, and the workers do not need to get into the breeding areas.

Specifically, the unmanned aerial vehicle body 100 and the wireless controller belong to the prior art. The structure of the unmanned aerial vehicle body 100 is the same as that of the unmanned aerial vehicle body currently available in the market. The device in the present disclosure can be obtained by modifying the unmanned aerial vehicle body available in the market.

A multi-rotor unmanned aerial vehicle is provided as the unmanned aerial vehicle body 100. Blade protection covers 110 are arranged on the blades of the unmanned aerial vehicle body 100. The blade protection covers 110 are used for protecting the blades and also protecting the bred animals. Because the blades are in a state of high-speed rotation during operation, the blades may hurt the animals that have not been driven away after the unmanned aerial vehicle body 100 lands. Therefore, it is required to arrange the blade protection covers 110 around the blades, and the blade protection covers 110 are of a mesh structure.

It should be noted that when the rotors of the unmanned aerial vehicle body 100 can be folded, the blade protection covers 110 are detachably connected to the unmanned aerial vehicle body 100. Furthermore, the blade protection covers 110 each include a spherical surface, a mesh protection cover, a mounting seat, and mounting rods. The mounting seat is in a circular ring shape. The mounting rods are arranged on an inner wall of the mounting seat. Several mounting rods are provided. The mounting rods are radially arranged in the mounting seat. The axes of the mounting rods pass through a center of the mounting seat. The mounting rods are integrated with the mounting seat. A mounting sleeve fixed to the mounting rods is arranged at the center of the mounting seat. The mounting sleeve is sleeved on a motor for the rotors. The protection cover is sleeved on the mounting seat through an interference connection, so that the blade protection covers 110 are detachable.

As a preferred embodiment, in this embodiment, automatic telescopic supporting feet are provided as the supporting feet 200. In some examples, electronic telescopic rods are provided as the supporting feet 200, and the supporting feet 200 are fixedly connected to the rotors of the unmanned aerial vehicle body 100 through screws. During sampling, the length of the supporting feet 200 is gradually shortened, so that the distance between the unmanned aerial vehicle body 100 and the ground is gradually reduced, so that the sampling unit 300 can conduct sampling deeply into feces to collect enough samples, thus the number of times of sampling at the same position is reduced.

It should be noted that a foot pad 210 is arranged at an end, away from the unmanned aerial vehicle body 100, of each of the supporting feet 200. The foot pad 210 is in a conical shape and made of rubber. The foot pad 210 is sleeved on the end, away from the unmanned aerial vehicle body 100, of each of the supporting feet 200 to increase the contact area between the supporting feet 200 and the ground, thereby preventing the supporting feet 200 from sinking into the ground.

In this embodiment, the supporting feet 200 are extended after sampling is finished, which can pull the sampling unit 300 out of the feces, so that the resistance during takeoff is reduced.

It should be noted that the expansion and retraction of the supporting feet 200 are automatically controlled by a control chip in the unmanned aerial vehicle body 100, and the expansion and retraction speed is related to the rotational resistance of the sampling unit 300. The correlation between the expansion and retraction speed and the rotational resistance is obtained by calculations and experiments. When the rotational resistance of the sampling unit 300 is high, the retraction speed of the supporting foot 200 is slow, and when the rotational resistance of the sampling unit 300 is low, the retraction speed of the supporting foot 200 is fast, so that the sampling unit 300 can always scrape samples during operation.

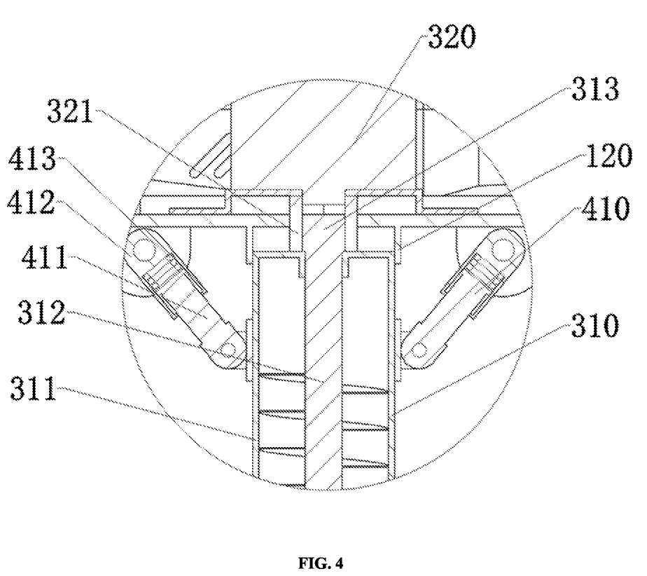

As shown in FIG. 3 and FIG. 4, the sampling tube 311 is of a cylindrical structure with an opening at an end. The sampling shaft 312 is rotatably connected to an end, away from the opening, of the sampling tube 311 through a shaft sleeve. The opening of the sampling tube 311 is formed in an end, away from the unmanned aerial vehicle body 100, of the sampling tube 311.

Preferably, a preset space is formed between ends, away from the opening of the sampling tube 311, of the spiral blades and a bottom of the sampling tube 311 for storing the samples. Predictably, the samples are solid, and when the sampling shaft 312 stops rotating, the samples in the sampling tube 311 will not roll off from the spiral blades under the action of friction between solids.

It should be noted that in this embodiment, the sampling operation of the sampling unit 300 can also be automatically carried out through a preset program, and the sampling power portion 320 is automatically started at a preset time after the landing of the unmanned aerial vehicle body 100, so that the sampling unit 300 automatically takes the samples.

As a preferred embodiment, in the present embodiment, the sampling portion 310 is detachably connected with the unmanned aerial vehicle body 100. The sampling device further includes:
a clamping unit 400 fixedly connected to the unmanned aerial vehicle body 100 for clamping the sampling portion 310.

In this embodiment, the sampling portion 310 is detachably connected with the unmanned aerial vehicle body 100. After sampling is finished, the sampling portion 310 is disassembled, and a new sampling portion 310 can be installed. Meanwhile, the clamping unit 400 is controlled to be detached from the sampling portion 310. After the sampling portion 310 is disassembled, a new sampling portion 310 is installed, and the clamping unit 400 is controlled to clamp the sampling portion 310.

In this embodiment, the clamping unit 400 can be controlled by a control button arranged on the unmanned aerial vehicle body 100, and can also be controlled by a wireless controller. The control mode is to send a control signal to a processing chip in the unmanned aerial vehicle body 100 through the control button or the wireless controller to control the clamping unit 400.

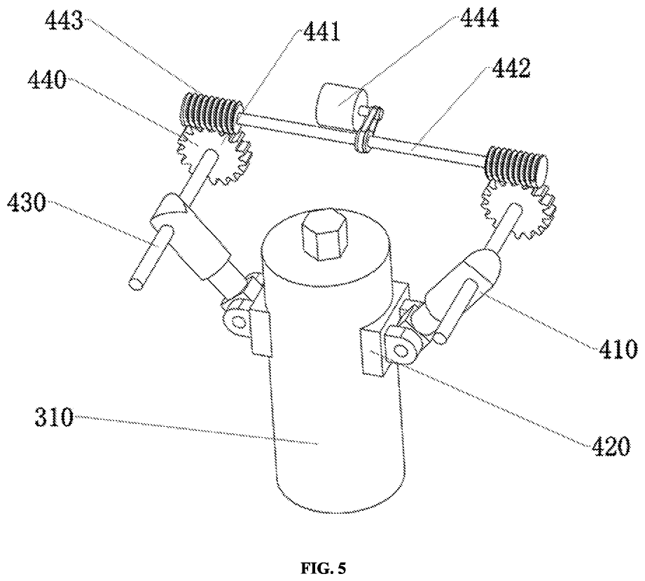

As a preferred embodiment, in this embodiment, as shown in FIG. 4 and FIG. 5, the clamping unit 400 includes:
two clamping arms 410 arranged on both sides of the sampling portion 310; the clamping arms 410 are hinged to the unmanned aerial vehicle body 100;
clamping plates 420 arranged on the clamping arms 410; surfaces, close to the sampling portion 310, of the clamping plates 420 are in an arc shape to fit the sampling portion 310; and
clamping power portions 440 fixedly connected to the unmanned aerial vehicle body 100 for driving the clamping arms 410 to rotate and clamp the sampling portion 310.

In this embodiment, when the sampling portion 310 is required to be released, the clamping arms 410 are driven to rotate in a direction away from the sampling portion 310 through the clamping power portions 440, so that the clamping plates 420 are detached from the sampling portion 310. When the sampling portion 310 is required to be clamped, the clamping arms 410 are driven to rotate in a direction towards the sampling portion 310 through the clamping power portions 440 to clamp the sampling portion 310.

In this embodiment, the clamping plates 420 are hinged to an end, away from the unmanned aerial vehicle body 100, of the clamping arms 410. The clamping plates 420 are connected with the clamping arms 410 through pins and lugs. The clamping plates 420 are connected with the clamping arms 410 through frictional damping between the pins and the lugs. The clamping arms 410 are hinged to the unmanned aerial vehicle body 100 through clamping shafts 430. Connecting lugs are arranged on the unmanned aerial vehicle body 100. The clamping shafts 430 are rotatably connected to the connecting lugs. The clamping arms 410 are fixedly connected with the clamping shafts 430 through key shaft connections. The clamping power portions 440 drive the clamping shafts 430 to rotate so as to drive the clamping arms 410 to rotate.

Preferably, in this embodiment, as shown in FIG. 5, the clamping power portions 440 each include:
a worm gear 441 arranged at an end of a corresponding one of the clamping shafts 430;
a clamping power shaft 442 rotatably connected into the unmanned aerial vehicle body 100; worms 443 rotating in opposite directions are arranged at both ends of the clamping power shaft 442; the worms 443 are meshed with the worm gears 441; and
a clamping motor 444 fixedly connected to the unmanned aerial vehicle body 100 for driving the clamping power shaft 442 to rotate.

The clamping power shaft 442 is rotatably connected to the unmanned aerial vehicle body 100 through a shaft seat. The shaft seat is fixedly connected to the unmanned aerial vehicle body 100 through screws. The clamping motor 444 is fixedly connected to the unmanned aerial vehicle body 100 through screws. In case that the clamping motor 444 drives the clamping power shaft 442 to rotate through a belt structure, when the clamping motor 444 rotates, the clamping motor 444 drives the clamping power shaft 442 to rotate, and the clamping power shaft 442 drives the two worms 443 to rotate. The two worms 443 rotate in opposite directions, the clamping power shaft 442 drives the worm gears 441 to rotate in opposite directions through the worms 443, thus, the two worm gears 441 can be driven to clamp/release the sampling portion 310.

Preferably, a connecting sleeve 321 is arranged on an output shaft of the sampling power portion 320. A connector 313 is arranged on the sampling shaft 312. When the connector 313 is inserted into the connecting sleeve 321, the sampling power portion 320 can drive the connector 313 to rotate. In some examples, the connector 313 is of a hexagonal prism structure, a hexagonal sleeve is provided as the connecting sleeve 321, and the connecting sleeve 321 is fixedly connected to the sampling power portion 320 through screws.

Preferably, a guide sleeve 120 is further arranged on the unmanned aerial vehicle body 100. The guide sleeve 120 is arranged on an outer side of the connecting sleeve 321, and is coaxially arranged with the connecting sleeve 321. When the sampling portion 310 is installed, the sampling portion 310 is inserted into the guide sleeve 120. Meanwhile, the connector 313 is inserted into the connecting sleeve 321. When the sampling portion 310 is clamped by the clamping unit 400, force directed towards the sampling power portion 320 along an axis of the sampling portion 310 can also be provided, so that the sampling portion 310 is fastened on the unmanned aerial vehicle body 100.

### Embodiment II

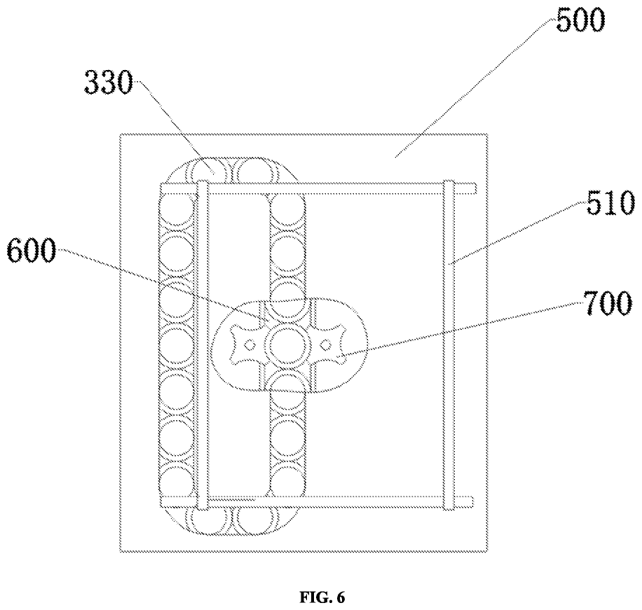

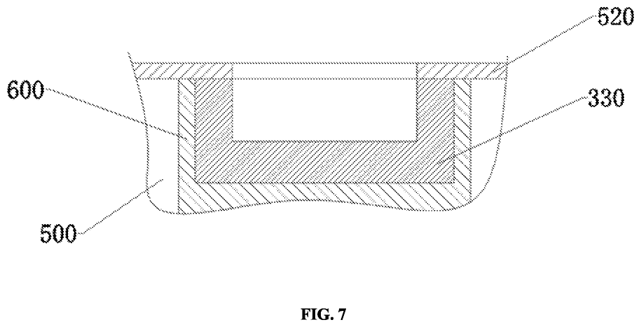

In one embodiment of the present disclosure, as shown in FIG. 4, FIG. 6 and FIG. 7, this embodiment differs from Embodiment I in that the clamping unit 400 is telescopic. The device further includes:
a hangar 500, a centering component is arranged on the hanger 500 to adjust position of the unmanned aerial vehicle body 100 on the hanger 500;
a sample bank 600 arranged in the hangar 500; an annular groove is provided as the sample bank 600; several sampling bases 330 are arranged in the sample bank 600; the sampling bases 330 are each in a cylindrical shape with an opening at one end; and the sampling portion 310 can be inserted into the sampling bases 330 through the clamping unit 400;
base moving wheels 700 arranged in the hangar 500 for controlling the sampling bases 330 to move in the sample bank 600; and the base moving wheels 700 are connected with a moving motor.

As shown in FIG. 6, a square ring is provided as the sample bank 600, and the corners of the sample bank 600 are configured to be rounded corners. The sampling bases 330 are pressed into the sample bank 600 through a hangar upper cover plate 520. The hanger upper cover plate 520 is pressed against the edge of the sampling bases 330, and a through hole with the same shape as the sample bank 600 is formed in the hangar upper cover plate 520. The base moving wheels 700 are each of a disc-shaped structure with several arc notches at an edge. An output shaft of the moving motor is fixed to the center of the base moving wheels 700. The arc notches in the base moving wheels 700 fit the sampling bases 330, and the adjacent sampling bases 330 in the sample bank 600 fit each other. When the base moving wheels 700 rotate, the base moving wheels 700 push the sampling bases 330 to move in the sample bank 600. Since the sampling bases 330 are limited by the sample bank 600, the sampling bases 330 push each other, so that all the sampling bases 330 move in the sample bank 600 along the edge of the sample bank 600. When the base moving wheels 700 rotate once, the sampling bases 330 move to the preset positions.

Anew sampling portion 310 is connected with one of the sampling bases 330.

When the unmanned aerial vehicle body 100 is parked on the hangar 500, the clamping unit 400 clamps the sampling portion 310, and the clamping arms 410 rotate. When the clamping arms 410 clamp the sampling portion 310, the clamping power portions 440 continue to drive the clamping arms 410 to rotate at a preset angle. Meanwhile, the length of the clamping arms 410 is shortened. Since two clamping arms 410 are provided, the sampling portion 310 moves in a straight line under the driving of the clamping arms 410, so that the sampling portion 310 is installed in the guide sleeve 120. The sampling power portion 320 slowly rotates until the connector 313 is inserted into the sampling shaft 312. When the sampling portion 310 is disassembled, the clamping motor 444 rotates in an opposite direction, the sampling portion 310 is firstly pulled out through the clamping arms 410, and then the sampling portion 310 is inserted into one of the sampling bases 330. Then, the base moving wheels 700 rotate, and the base moving wheels 700 control the sampling bases 330 to move by a preset distance. The new sampling base 330 and the sampling portion 310 move below the unmanned aerial vehicle body 100, and the new sampling portion 310 is installed between the clamping power portions 440, so that the sampling portion 310 is automatically replaced.
as shown in FIG. 4, the clamping arms 410 each include a telescopic arm 411, a fixed arm 412, and a spring 413. An end of the telescopic arm 411 is slidably connected to the fixed arm 412. The spring 413 is arranged in the fixed arm 412, and both ends of the spring 413 respectively abut against the telescopic arm 411 and the fixed arm 412. The fixed arm 412 is in a cylindrical shape with an opening at one end. When the length of the clamping arm 410 is shortened, the spring 413 is compressed.

It should be noted that an outer stopper ring is arranged at an end, located in the fixed arm 412, of the telescopic arm 411, and an inner stopper ring is arranged at an opening of the fixed arm 412 to prevent the telescopic arm 411 from detaching from the fixed arm 412.

In this embodiment, the hangar 500 is an unmanned aerial vehicle hangar in the prior art. The centering component 510 is a centering structure in the prior art. The structure in the hangar 500 and the structures of the electronic components and the centering component 510 are those in the prior art. The hangar 500 in the present disclosure can be obtained by modifying the unmanned aerial vehicle hangar in the prior art.

### Embodiment III

A sampling method for feces in a poultry house is further provided in the present disclosure. The method includes the following steps:
step SA, selecting a sampling position based on a virtual map of a poultry house; and
step SB, moving the unmanned aerial vehicle body 100 to the sampling position based on virtual coordinates of the sampling position, starting the sampling unit 300 to scrape samples, and then flying back to the starting point.

Specifically, in this embodiment, firstly, the virtual map of a poultry house is established. The virtual map is pre-stored in the wireless controller and the unmanned aerial vehicle body 100. during sampling, a sampling site is input through a display device and a touch device of the wireless controller. The wireless controller sends coordinates of the sampling site to a processing device in the unmanned aerial vehicle body 100. The unmanned aerial vehicle body 100 starts and flies to a coordinate position after receiving the coordinates, and the sampling power portion 320 is started after landing at the coordinate position. The sampling unit 300 takes samples after the sampling power portion 320 is started.

In case that the device in Embodiment II is provided as the sampling device, after sampling is finished, the unmanned aerial vehicle body 100 flies back to the hangar 500. The hangar 500 centers the unmanned aerial vehicle body 100 through the centering component 510, and then the clamping unit 400 is started. The sampling portion 310 is detached and inserted into one of the sampling bases 330, and then the base moving wheels 700 are started. The sampling bases 330 move in the sample bank 600, and the new sampling portion 310 is replaced through the clamping unit 400. Although the embodiments of the present disclosure have already been illustrated and described, various changes, modifications, replacements and transformations can be made by those skilled in the art without departing from the principle and the spirit of the present disclosure, and thus the scope of the present disclosure should be limited by claims and equivalents thereof.

What is claimed is:

1. A long-distance sampling device for feces in a poultry house, comprising:
an unmanned aerial vehicle body comprising a wireless controller for controlling flight of the unmanned aerial vehicle body;
supporting feet arranged on the unmanned aerial vehicle body;
a sampling unit arranged on the unmanned aerial vehicle body for collecting fecal samples, wherein the sampling unit comprises:
a sampling power portion arranged in the unmanned aerial vehicle body;
a sampling portion arranged on the unmanned aerial vehicle body; the sampling portion comprises a cylindrical sampling tube and a sampling shaft rotatably connected to the sampling tube; spiral blades are fixedly connected to the sampling shaft; and the sampling power portion drives the sampling shaft to rotate.

2. The long-distance sampling device for feces in a poultry house according to claim 1, wherein blade protection covers are arranged on the blades of the unmanned aerial vehicle body.

3. The long-distance sampling device for feces in a poultry house according to claim 1, wherein automatic telescopic supporting feet are provided as the supporting feet.

4. The long-distance sampling device for feces in a poultry house according to claim 1, wherein the sampling tube is of a cylindrical structure with an opening at one end, and the opening of the sampling tube is formed in one end, away from the unmanned aerial vehicle body, of the sampling tube; and
a preset space is formed between ends, away from the opening of the sampling tube, of the spiral blades and a bottom of the sampling tube for storing the samples.

5. The long-distance sampling device for feces in a poultry house according to claim 1, wherein the sampling portion is detachably connected with the unmanned aerial vehicle body, and the sampling device further comprises:
a clamping unit fixedly connected to the unmanned aerial vehicle body for clamping the sampling portion.

6. The long-distance sampling device for feces in a poultry house according to claim 2, wherein the sampling portion is detachably connected with the unmanned aerial vehicle body, and the sampling device further comprises:
a clamping unit fixedly connected to the unmanned aerial vehicle body for clamping the sampling portion.

7. The long-distance sampling device for feces in a poultry house according to claim 3, wherein the sampling portion is detachably connected with the unmanned aerial vehicle body, and the sampling device further comprises:
a clamping unit fixedly connected to the unmanned aerial vehicle body for clamping the sampling portion.

8. The long-distance sampling device for feces in a poultry house according to claim 4, wherein the sampling portion is detachably connected with the unmanned aerial vehicle body, and the sampling device further comprises:
a clamping unit fixedly connected to the unmanned aerial vehicle body for clamping the sampling portion.

9. The long-distance sampling device for feces in a poultry house according to claim 5, wherein the clamping unit comprises:
two groups of clamping arms arranged on both sides of the sampling portion; the clamping arms are hinged to the unmanned aerial vehicle body;
clamping plates arranged on the clamping arms; surfaces, close to the sampling portion, of the clamping plates are in an arc shape to fit the sampling portion; and
clamping power portions fixedly connected to the unmanned aerial vehicle body for driving the clamping arms to rotate and clamp the sampling portion.

10. The long-distance sampling device for feces in a poultry house according to claim 6, wherein the clamping unit comprises:
two groups of clamping arms arranged on both sides of the sampling portion; the clamping arms are hinged to the unmanned aerial vehicle body;
clamping plates arranged on the clamping arms; surfaces, close to the sampling portion, of the clamping plates are in an arc shape to fit the sampling portion; and
clamping power portions fixedly connected to the unmanned aerial vehicle body for driving the clamping arms to rotate and clamp the sampling portion.

11. The long-distance sampling device for feces in a poultry house according to claim 7, wherein the clamping unit comprises:
two groups of clamping arms arranged on both sides of the sampling portion; the clamping arms are hinged to the unmanned aerial vehicle body;
clamping plates arranged on the clamping arms; surfaces, close to the sampling portion, of the clamping plates are in an arc shape to fit the sampling portion; and
clamping power portions fixedly connected to the unmanned aerial vehicle body for driving the clamping arms to rotate and clamp the sampling portion.

12. The long-distance sampling device for feces in a poultry house according to claim 8, wherein the clamping unit comprises:
two groups of clamping arms arranged on both sides of the sampling portion; the clamping arms are hinged to the unmanned aerial vehicle body;
clamping plates arranged on the clamping arms; surfaces, close to the sampling portion, of the clamping plates are in an arc shape to fit the sampling portion; and
clamping power portions fixedly connected to the unmanned aerial vehicle body for driving the clamping arms to rotate and clamp the sampling portion.

13. The long-distance sampling device for feces in a poultry house according to claim 9, wherein the clamping arms are hinged to the unmanned aerial vehicle body through clamping shafts, and the clamping power portions each comprise:
a worm gear arranged at an end of a corresponding one of the clamping shafts;
a clamping power shaft rotatably connected to the unmanned aerial vehicle body; worms rotating in opposite directions are arranged at both ends of the clamping power shaft; the worms are meshed with the worm gears; and
a clamping motor fixedly connected into the unmanned aerial vehicle body for driving the clamping power shaft to rotate.

14. The long-distance sampling device for feces in a poultry house according to claim 10, wherein the clamping arms are hinged to the unmanned aerial vehicle body through clamping shafts, and the clamping power portions each comprise:
a worm gear arranged at an end of a corresponding one of the clamping shafts;
a clamping power shaft rotatably connected to the unmanned aerial vehicle body; worms rotating in opposite directions are arranged at both ends of the clamping power shaft; the worms are meshed with the worm gears; and
a clamping motor fixedly connected into the unmanned aerial vehicle body for driving the clamping power shaft to rotate.

15. The long-distance sampling device for feces in a poultry house according to claim 11, wherein the clamping arms are hinged to the unmanned aerial vehicle body through clamping shafts, and the clamping power portions each comprise:
a worm gear arranged at an end of a corresponding one of the clamping shafts;
a clamping power shaft rotatably connected to the unmanned aerial vehicle body; worms rotating in opposite directions are arranged at both ends of the clamping power shaft; the worms are meshed with the worm gears; and
a clamping motor fixedly connected into the unmanned aerial vehicle body for driving the clamping power shaft to rotate.

16. The long-distance sampling device for feces in a poultry house according to claim 12, wherein the clamping arms are hinged to the unmanned aerial vehicle body through clamping shafts, and the clamping power portions each comprise:
a worm gear arranged at an end of a corresponding one of the clamping shafts;
a clamping power shaft rotatably connected to the unmanned aerial vehicle body; worms rotating in opposite directions are arranged at both ends of the clamping power shaft; the worms are meshed with the worm gears; and
a clamping motor fixedly connected into the unmanned aerial vehicle body for driving the clamping power shaft to rotate.

17. The long-distance sampling device for feces in a poultry house according to claim 9, wherein the device further comprises:
a hangar, a centering component is arranged on the hanger to adjust position of the unmanned aerial vehicle body on the hanger;
a sample bank arranged in the hangar; an annular groove is provided as the sample bank; several sampling bases are arranged in the sample bank; the sampling bases are each in a cylindrical shape with an opening at one end; and the sampling portion is capable of being inserted into one of the sampling bases through the clamping unit;
base moving wheels arranged in the hangar for controlling the sampling bases to move in the sample bank; and the base moving wheels are connected with a moving motor.

18. The long-distance sampling device for feces in a poultry house according to claim 13, wherein the device further comprises:
a hangar, a centering component is arranged on the hanger to adjust position of the unmanned aerial vehicle body on the hanger;
a sample bank arranged in the hangar; an annular groove is provided as the sample bank; several sampling bases are arranged in the sample bank; the sampling bases are each in a cylindrical shape with an opening at one end; and the sampling portion is capable of being inserted into one of the sampling bases through the clamping unit;
base moving wheels arranged in the hangar for controlling the sampling bases to move in the sample bank; and the base moving wheels are connected with a moving motor.

19. The long-distance sampling device for feces in a poultry house according to claim 17, wherein the base moving wheels are each of a disc-shaped structure with several arc notches at an edge, and the arc notches in the base moving wheels fit the sampling bases.

20. The long-distance sampling device for feces in a poultry house according to claim 17, wherein the clamping arms each comprise a telescopic arm, a fixed arm, and a spring; an end of the telescopic arm is slidably connected to the fixed arm; the spring is arranged in the fixed arm, and both ends of the spring respectively abut against the telescopic arm and the fixed arm; and a the fixed arm is in the shape in a cylinderical shape with an opening at one end.
